(19) United States
(12) Patent Application Publication
(10) Pub. No.: US 2025/0245685 A1
(43) Pub. Date: Jul. 31, 2025

(54) Computer Implemented Method for Answering Surveys using Large Language Models

(71) Applicants: David Ho, Gardena, CA (US); Warren Chao, Gardena, CA (US)

(72) Inventors: David Ho, Gardena, CA (US); Warren Chao, Gardena, CA (US)

(21) Appl. No.: 18/427,517

(22) Filed: Jan. 30, 2024

(51) Int. Cl. G06Q 30/0203

(52) U.S. Cl. CPC G06Q 30/0203

(57) ABSTRACT

This invention presents a computer-implemented method for answering polls and surveys using large language models (LLMs), a novel approach that leverages an LLM's ability to emulate a group of human responses for diverse data collection. The system involves training a single or multi-modal LLM on a comprehensive dataset comprising one or more categories of text, image, sound and other sensory input data, which can be continuously updated with current events and trends, to ensure accurate representation of human behaviors and opinions. Utilizing a user interface, the method includes receiving survey and poll questions, posing these questions to a unique instance of the trained LLM and receiving the answers, recording the question-answer sessions, and compiling the results for presentation. Additionally, the system prioritizes data privacy and integrates a feedback mechanism for continuous improvement, providing an efficient solution to answering surveys or polls in the digital age.

### BACKGROUND

The intersection of advanced technologies and traditional survey methods has given rise to the innovative use of large language models (LLMs) in polling and surveys. This shift is driven by the limitations of conventional survey techniques, such as high costs, time-intensive processes, and susceptibility to biases. Single or multi-modal LLMs, trained on a combination of one or more categories of extensive text, image, sound and other sensory input data, offer a new paradigm for emulating human responses in surveys, addressing these challenges by providing scalable, efficient, and potentially more diverse methods of data collection, querying and analysis.

The development of single or multi-modal LLMs for survey purposes is a response to the need for more adaptable and accurate data collection tools in various industries. These models, trained on vast repositories of structured data (such as text, images, sound and other sensory input), answer questions by predicting the most likely structured data (such as words) that would compose an answer, thereby providing a novel approach to emulating human behavior. The further ability to provide updated, external knowledge sources into LLMs also enhances their ability to stay relevant and accurate, making them suitable for dynamic environments where opinions and trends rapidly evolve.

A significant challenge in this domain is the inherent bias and censorship present in LLMs, which can lead to misalignment with the nuanced opinions of diverse demographic groups. Studies have highlighted the necessity for these models to accurately reflect the breadth of human perspectives, ensuring that the responses generated are unbiased and representative of all sections of society. Tools like OpinionQA have been developed to evaluate and mitigate these biases, comparing LLM outputs with public opinion polling data to ensure alignment with diverse viewpoints.

Efforts have been made to create LLM-based polling methods that are balanced and representative of various demographic subgroups. This approach enhances the capability of LLMs to generate a vast array of responses, offering a more comprehensive and inclusive view of public opinion. These advancements address the need for more effective representation of views, especially from groups that might be underrepresented in traditional survey methods.

In summary, the integration of LLM technology in polling and surveying signifies a major advancement in the field. The ongoing developments aim to surpass the limitations of traditional methods, providing new avenues for more efficient, accurate, and inclusive data collection and analysis. This patent proposal aligns with these advancements, offering a new method that utilizes the capabilities of LLMs for conducting more effective and representative polls and surveys.

### SUMMARY

In view of the circumstances outlined above, aspects of the present invention disclose systems and methods to answer surveys using large language models.

One embodiment of the invention is a system that facilitates the creation of character cards to train unique instance(s) of the LLM, wherein cards encapsulate training data, which data includes, without limitation, demographic information, new facts, and individual survey respondents' responses. This training data could be single or multi-modal, meaning that it could be structured data representing one or more of text, images, sounds and other sensory input data.

The character cards can be based on actual human respondents, fictitious respondents created by humans, or fictitious respondents created by any other means-including another LLM. There is another method envisioned where actual human respondents are compensated for providing their initial data regarding demographics, preferences and interests, as well as updates to this data.

In any event, the resulting character cards can be loaded onto the LLM to create unique instances of the LLM, corresponding to an individual survey respondent.

These unique instances are used to answer new questions or confirm previous responses, with the system generating and analyzing written summaries (also called chatlogs) for each interaction. An automated scripting process enables querying of all unique instances with a set of questions. The system is scalable, capable of conducting and transcribing question-answer sessions from small-scale individual surveys to large-scale public opinion polls. It includes customizable templates and tools for adaptation across various industries, such as market research, political polling, social science research, and customer feedback. The system also features a security module that implements data encryption and access controls to ensure the security and integrity of training data and collected survey data that include the unique instance responses. In certain embodiments, the system's hardware configuration includes high-performance computing resources, and the software configuration comprises specialized modules for real-time data processing and analysis in diverse survey environments.

After creating the unique instances referred to above, according to another aspect of the present invention, there is provided a computer-implemented method and system for answering polls and surveys leveraging the abilities of single or multi-modal large language models. The trained unique instance(s) is deployed to emulate individual human behaviors and responses, and receiving survey or poll questions via a user interface or manually.

The system queries one or more unique instances of the LLM with the aforementioned new questions and generates responses that mirror the human behaviors, preferences and opinions that the unique instance of the LLM was trained on. These responses are processed to compile survey or poll results, which are then presented to the user via a user interface at a computer terminal and stored in the system. The trained unique instance(s) can be continuously updated with current preferences, events and trends to maintain the accuracy and relevance of the responses of such instance(s).

Advanced features of the system include training one or more unique instances of an LLM to represent specific demographic groups to enhance the diversity and representativeness of survey results. The system also includes: the ability to dynamically add, refine, and improve the training data for the instance(s) of the LLM; interactive user interface elements for customizing survey types and targeting specific demographics; and a privacy module to ensure compliance with data privacy regulations.

### BRIEF DESCRIPTION OF THE DRAWINGS

FIG. 1 is a block diagram illustrating how a user inputs training data and new questions to the system.

FIG. 2 is a continuation of the diagram describing the implementation of a character card generation process from the training data, loading the character card onto the LLM to create a unique instance of the LLM, asking the new questions to the unique instance, and transcribing the question-answer results.

FIG. 3 depicts how the process in FIG. 2 is repeated for all the unique instances to be used in a survey, how the chatlogs are stored, how the chatlog data is analyzed by the system, and how this analysis yields results that are presented to the user and stored in the system.

### DETAILED DESCRIPTION

### Data Input

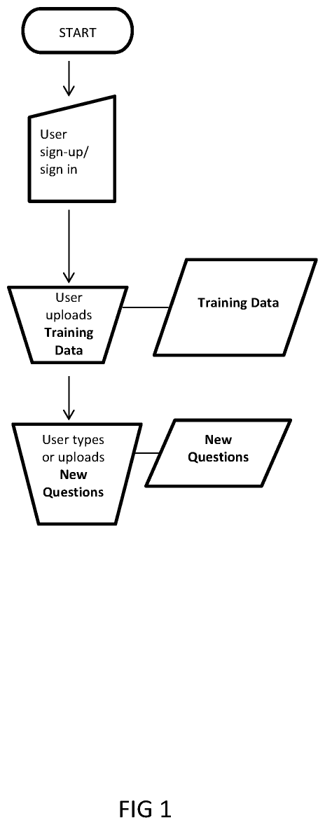

FIG. 1 displays the training data input interface and the new question input interface, created using HTML5, CSS, and React.js, allowing customers to upload training data and new questions. OAuth SSO integrates with the platform for secure user sign-up, sign-in and authentication. The user inputs or uploads training data that can consist of responses from X individuals to N questions, this training data is then processed by the backend system. This training data could also be multi-modal, meaning that it could be structured data representing text, images, sounds and other sensory input data. The user then also inputs new questions that are part of a survey for the trained unique instances of the LLM to be created below.

Character Card Generation, Integration with LLM, and Conducting One Session of a Survey

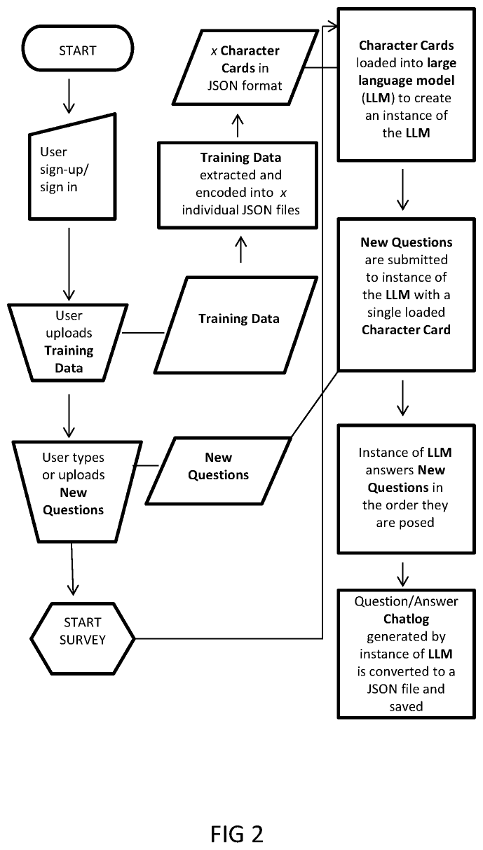

FIG. 2 describes the implementation of a character card generation process, loading the character card onto the LLM to create a unique instance of the LLM, posing the new questions in the survey to the unique instance so that it can answer them, and then recording the question-answer session. The character card generation process includes transforming the training data into structured formats achieved through the application of Python along with its robust libraries, Pandas and NumPy.

In this framework, the training data content of the character cards is refined using NLTK and spaCy, libraries which provide essential NLP tasks like tokenization, entity recognition, and parsing. Alternatively for training data that involve multi-modal information such as images-computer vision libraries such as OpenCV could be used. Subsequently, the data undergoes JSON encoding, converting the processed information into character cards which are formatted in a manner which is universally compatible and ideal for integration with Large Language Models (LLMs). In some embodiments the training data for the character cards include single or multi-modal information comprising demographic information, and personal preferences and opinions across the cognitive and sensory spectrum that can be structured as question-answer pairs derived from the training data provide in FIG. 1, as well as additional information such as summaries of recent events and new data not contained in the base model of the original LLM.

As mentioned previously, an associated user interface serves as the platform for inputting or uploading training data and the new questions to be asked. Alternatively, the training data and new questions can be input manually.

Once in JSON format, the character cards are loaded into a single or multi-modal LLM base model (such as Meta's Llama 2), which are typically tables of vector weights analyzed with software technologies like TensorFlow or PyTorch, run on hardware that can include various NVIDIA graphical processor units that implement NVIDIA's CUDA (Compute Unified Device Architecture).

The system's backend conducts a survey through steps comprising: automating the loading of the character cards to create an instance of the LLM with an LLM interface such as textgenerationwebui; starting a question and answer session in the LLM interface—with each instance of the LLM answering the set of new questions; recording the entire question and answer session (also referred to as a chatlog); and then downloading the entire chatlog into a unique JSON file. One way of automating the implementation of the system's backend of loading character cards, querying all the instances of LLM with the new questions in the LLM interface, and downloading the chatlogs is utilizing a software automation tool such as SikuliX.

### Completing the Survey, Analyzing the Results and Presenting the Results to a User:

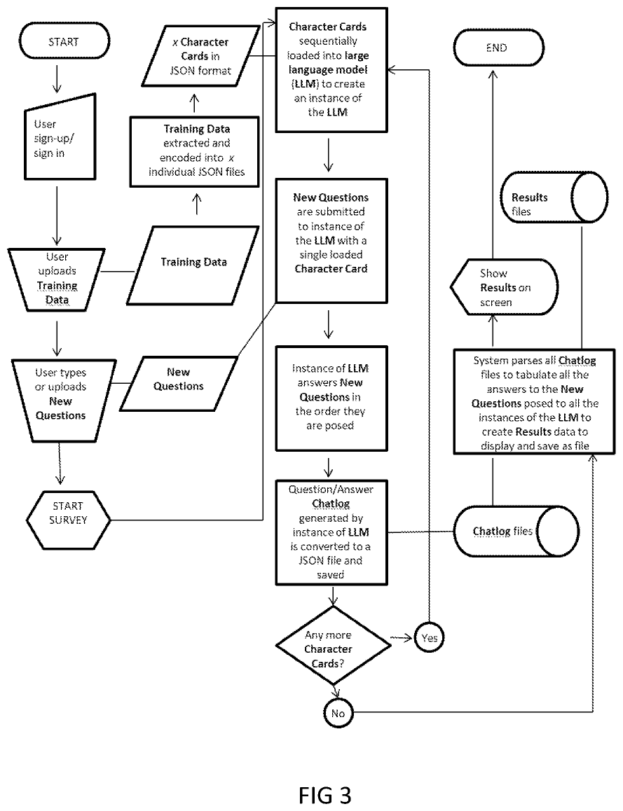

FIG. 3 depicts how the process in FIG. 2 is repeated for all the unique instances to be used in a survey, how the chatlogs are stored, how the chatlog data is analyzed by the system, and how this analysis yields results that are presented to the user and saved by the system. As previously shown in FIG. 1 and FIG. 2, the user can engage with the unique instances of the LLM through two main methods. The first, the Direct Query Method, allows users to directly ask the new questions to unique instances of the LLM. This interaction is enabled by the user typing in the questions questions in an LLM interface such as text-generation-webui by oobabooga. The second method, the Automated Scripting Approach as shown in FIG. 3, uses SikuliX to run a script that automates the sequential loading of the character cards to create unique instances, automatically queries each of the unique instances with the new questions, and saves the chatlogs. This automated approach allows for efficient and rapid data collection when surveying or polling multiple AI instances.

As mentioned earlier, each question-answer interaction with a unique instance, whether via direct queries or automated scripts, is recorded as a chatlog. The chatlogs are then analyzed and parsed using data processing frameworks like PowerShell to extract key insights and patterns, which are then summarized for the user within the system.

Additionally, these chatlogs are integrated into the system's central data repository, enabling longitudinal analysis and the ability to cross-reference chatlog data with other datasets. This integration offers a comprehensive view of interactions over time, enhancing the user's data analysis capabilities.

The system then presents the results of this analysis to the user on a computer screen and saves the analysis on computer storage.

The embodiments described above are given for the purpose of facilitating the understanding of the present described device and are not intended to limit the interpretation of the present described device. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1: A computer-implemented method for answering polls and surveys, comprising:
creating one or more instances of single or multi-modal large language model (LLM) that have been further trained on a single or multi-modal source of data (text, images, sounds and other sensory training data), which data can comprise information that corresponds to a hypothetical or real individual's responses to a set of questions that comprise the unique characteristics and/or preferences of an instance;
receiving, via a user interface or manually, questions;
querying the trained instance(s) of the LLM with the received questions;
recording the responses from the instance(s) of the LLM to the questions;
processing the responses to compile survey or poll results; and
presenting the compiled results on a user interface.

2: The method of claim 1, wherein each instance(s) of the LLM is trained on data embodied in a character card or other format, which data may contain one or more of the following: summaries of recent events, demographic information, and personal preferences and opinions (expressed in one or more modes of multi-modal data such as text, images, sounds and other sensory frameworks) that can be structured as question-answer pairs, all of which have been transformed and formatted for input into an LLM.

3: The method of claim 1, wherein the data for training the instance(s) of the LLM is sourced from a real individual, who is providing information that accurately reflects their real world behaviors and preferences;

4: The method of claim 1, wherein the data for training the instance(s) of the LLM is sourced from a fictional character with fictitious behaviour and preferences.

5: The method of claim 1, wherein the data for training the instance(s) of the LLM instance is sourced from synthetic data generated by another LLM.

6: The method of claim 1, wherein the training of the instance(s) of the LLM includes updating the training data with current events, trends and/or preferences to maintain the relevance and accuracy of the responses made by the instance(s) of the LLM.

7: The method of claim 1, further comprising a step of summarizing the responses of the instances of the LLM using natural language processing techniques to provide analytical insights into the poll or survey data.

8: A system for conducting polls and surveys, comprising:
An instance(s) of a single or multi-modal large language model (LLM) trained to emulate responses from a hypothetical or real human to a single or multiple modes of input including text, images, sounds or other sensory input;
a training module for updating the instance(s) of the LLM with current events, trends or preferences;
a user interface for receiving questions;
a processing unit for querying the instance(s) of the LLM with the user questions and compiling responses; and
an analysis module for summarizing and interpreting the responses from the instance(s) of the LLM.

9: The method of claim 1, wherein the instance(s) of the LLM is trained to emulate responses from specific demographic groups, enhancing the diversity and representativeness of the survey results.

10: The method of claim 1, further comprising a feedback mechanism wherein the responses generated by each instance of the LLM are used to refine and improve the training data.

11: The method of claim 1, wherein the user interface includes interactive elements allowing users to specify the type of survey, target demographic, and response format.

12: The method of claim 1, further including a privacy module to ensure that the data used for training the instance of the LLM and the responses generated are compliant with data privacy regulations.

13: A method for creating one or more character cards representing individual survey respondents, wherein each card encapsulates one individual's responses to questions spanning a single or multiple modes of input including text, images, sounds or other sensory input, and facts and demographic information for each survey respondent sourced via methods described in claims 3, 4, 5, and 22.

14: The method of claim 13, further comprising loading a character card into a single or multi-modal LLM to create a corresponding unique instance of the LLM for each original survey respondent.

15: The method of claim 14, wherein unique instances of the LLM are used to answer new questions or confirm previous responses, with the system recording and analyzing text transcriptions of the question-answer sessions (also called chatlogs) with each unique instance of the LLM.

16: The method of claim 14, further including an automated scripting process to query the aforementioned unique instances of the LLM with a set of questions.

17: A system for conducting polls and surveys, comprising a module for creating and managing unique instance(s) of a single or multi-modal large language model (LLM) that have been further trained on a single or multi-modal source of data (text, images, sounds and other sensory training data), which data can comprise information that corresponds to a hypothetical or real individual's responses to a set of questions that comprise the unique characteristics and/or preferences of an instance, a module that accepts the question(s) to ask the unique instance(s) of an LLM, a module that records a chatlog of the question-answer session with the unique instance of the LLM, and a chatlog analysis tool for parsing the question-answer sessions with these unique instances of the LLM.

18: The method of claim 1, further comprising a scalability module enabling the system to adaptively conduct and transcribe question-answer sessions from small-scale individual surveys to large-scale public opinion polls.

19: The method of claim 1, wherein the system includes customizable templates and tools allowing adaptation for various industries such as marketing, political polling, social research, and customer feedback.

20: The method of claim 1, further including a security module that implements data encryption and access controls to ensure the security and integrity of collected survey data and responses from the instances of the LLM.

21: The system of claim 8, wherein the hardware configuration includes high-performance computing resources and the software configuration includes specialized modules for real-time data processing and analysis in diverse survey environments.

22: The method of claim 3, further comprising a system of compensating the individual for providing and updating their real world behaviors and preferences.
